(19) United States
(12) Patent Application Publication
(10) Pub. No.: US 2024/0116779 A1
(43) Pub. Date: Apr. 11, 2024

(54) METHOD AND DEVICE FOR INCREASING HYDRATION FROM WATER

(71) Applicant: KEVIN E. FLAMMANG, ORANGE CITY, IA (US)

(72) Inventor: KEVIN E. FLAMMANG, ORANGE CITY, IA (US)

(21) Appl. No.: 18/484,838

(22) Filed: Oct. 11, 2023

Related U.S. Application Data
(60) Provisional application No. 63/379,108, filed on Oct. 11, 2022.

(51) Int. Cl. C02F 1/34; C02F 1/00

(52) U.S. Cl. CPC C02F 1/34; C02F 1/005; C02F 2103/026

(57) ABSTRACT

A process for treating water includes the steps of passing the water through a conduit having spaced apart cavitation zones and a central laminar flow zone to increase negative hydrogen ions in the water, to increase electron activity, and to decrease molecular clustering, and thereby reduce surface tension of the water for improved hydration by a body consuming the water, including people, animals, and plants.

### CROSS REFERENCE TO RELATED APPLICATIONS

This application claims priority under 35 U.S.C. § 119 to provisional patent application U.S. Ser. No. 63/379,108, filed Oct. 11, 2022. The provisional patent application is herein incorporated by reference in its entirety, including without limitation, the specification, claims, and abstract, as well as any figures, tables, appendices, or drawings thereof.

### TECHNICAL FIELD

The invention is directed towards a method of treating water so as to reduce surface tension and increase negative hydrogen ions of the water so that the water will be more readily absorbed by humans, animals, and plants for increased hydration.

### BACKGROUND

Body hydration is an important aspect of a healthy body. Dehydration can lead to a variety of health issues. The ability of a body, whether plant, animal, or human, to absorb water for hydration is related to the surface tension of the water. Higher surface tension causes less absorption, and thus, less hydration. For example, tap water typically has a surface tension of 80-85 dynes. A lower dyne value would increase water absorption, and thus improve the health of the body.

Water which has been treated to remove “hard” water minerals, and thereby produce “soft” water, also loses electron activity and hydrogen ionization. Such water softening treatment processes, such as reverse osmosis, increase the surface tension of the water molecules, which makes it more difficult for bodies to absorb the water for hydration.

Therefore, a primary objective of the present invention is the provision of a method for increasing water hydration for improved health benefits in humans, animals and plants.

Another objective of the present invention is the provision of a method for reducing the surface tension of water.

A further objective of the present invention is the provision of a method for increasing the hydrogen ions in water.

Still another objective of the present invention is a provision of a water treatment method which overcomes the adverse effects of electron deactivation.

Another objective of the present invention is the provision of a conduit for treating water to improve the hydration properties of the water.

A further objective of the present invention is the provision of a tube having cavitation balls or deflectors which change the properties of the water as the water passes through the tube.

Still another objective of the present invention is the provision of a water pipe which treats the water passing therethrough to increase hydrogen ions and reduce surface tension.

Another objective of the present invention is the provision of a method and device to revitalize “dead” water.

A further objective of the present invention is the provision of a method and device to increase electron activity in water molecules.

Yet another objective of the present invention is the provision of a method and device to reduce the size of water molecule clusters for improved absorption of the water molecules by a body.

Yet another objective of the present invention is a provision of a treatment process for water which is economical and effective.

Yet another objective of the present invention is a provision of a treatment process for water which is economical and effective.

A further objective of the present invention is the provision of a treatment process for water which is economical and effective.

These and other objectives will become apparent from the following description of the invention.

### SUMMARY

A method and device are provided for treating water to reduce surface tension and thereby improve absorbability of the water by humans, animals, and plants. The method and device a conduit having spaced apart sets of demagnetized stainless steel balls or deflectors, through which the water flows, which lowers the surface tension of the water and increases negative hydrogen ions in the water.

### BRIEF DESCRIPTION OF THE DRAWINGS

FIG. 1 is a schematic flow diagram showing one method of the present invention for treating water to improve its hydration properties.

FIG. 2 is a longitudinal cross-sectional view of a first embodiment of the device comprising a conduit or pipe according to the present invention for revitalizing the mineralized water.

FIG. 3 is a lateral cross-sectional view of the conduit shown in FIG. 2.

FIG. 4 is a photograph showing the components of a second embodiment of the device of the present invention.

FIG. 5 is a sketch showing a sectional view of the second embodiment of the device.

FIG. 6 is a sketch showing a sectional view of the components of the second embodiment, without the cavitation balls for clarity.

FIG. 7 is a photo showing the components of the device, with the outer sleeve removed.

### DETAILED DESCRIPTION

Water treatment using the assembly of the present invention will decrease the surface tension of the water molecules, and thereby increase the ability of a body to be able to absorb the water, for improved hydration of the body. Also, water with deficient electron activity can be revitalized with the methods of the present invention. The process of the present invention involves flowing the water through a conduit connected to a water pipe or hose. The water in the conduit is subjected to cavitation, then rest, then another cavitation. The intermediate rest or reduced turbulence for the water between cavitations, enhances the water quality by increasing the ionization of molecules.

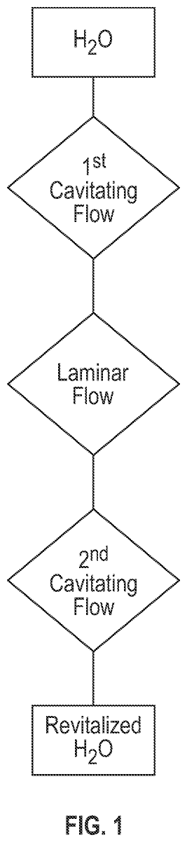

For example, in FIG. 1, the water, or other low mineral water, is cavitated, then subjected to reduced turbulence with more laminar flow, and then cavitated a second time.

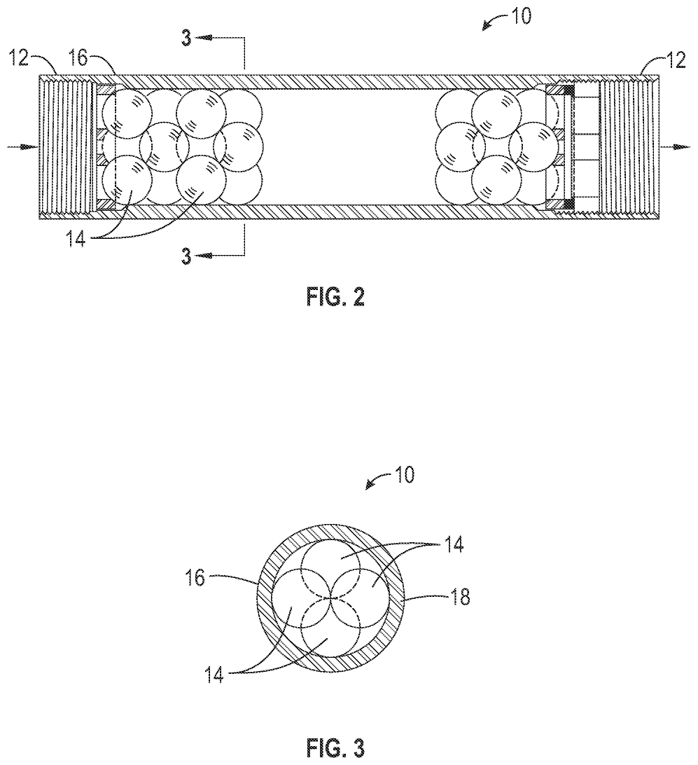

In the preferred embodiment, the water passes through a conduit, pipe or tube 10, which transforms the water quality to an improved or enhanced condition by decreasing molecular surface tension and increasing negative hydrogen ions in the water. The conduit 10 has opposite threaded ends 12 for installation in a water supply line, such as a pipe or hose. A plurality of deflectors 14 are located inside the conduit 10. As seen in FIG. 2, there are two sets of deflectors 14, with one set being located at each end of the pipe 10, and a space between the two sets. The number of deflectors at each end may vary, as may the distance between the two sets. The length and diameter of the tube may also vary. Preferably, the deflectors 14 are demagnetized stainless steel balls, though other forms of deflectors may be utilized. Also, the balls 14 are preferably arranged in a predetermined array, such as layers or rows of offset balls, over which the water flows so as to create cavitation for the water, similar to that derived from a stream wherein the water flows over stones or rocks. In the drawings, the balls are arranged in 2×2 arrays, with each subsequent row of balls offset 90 degrees from the prior set of balls. This configuration of the cavitation balls maximizes the cavitation by creating a circuitous path for the water through the pipe, while minimizing flow path around the balls such that the rate of water flow through the pipe is not overly restricted. The 2×2 array also maximizes the diameter of the balls 14, as compared to a 3×3 array which would offset each row of balls at 60 degrees, or a 4×4 array which would offset each row at 40 degrees. This cavitation causes the hydrogen molecules of the water to transform to create increased negative ions, which decreases the surface tension of the water, which in turn allows the water to be more readily absorbed into the cells of the body of a human, animal, or plant which consumes the water. The cavitation may include tumbling, spinning, twirling, stirring, vortexing, or spiraling. Between the two sets of balls 14, the water flows more laminarly or more smoothly, substantially parallel to the longitudinal axis of the pipe 10, as compared to the turbulent or non-parallel flow around the balls.

The cavitation balls 14 activate the oxygen molecules in the water, and in turn releases or creates negative hydrogen ions. The resulting lower surface tension of the water molecules decreases the dynes, which allows the water to be more readily absorbed into the cells of the body. The treated water preferably has a surface tension in the range of 32-42 dynes, approximately ½ the value of conventional tap water. This reduced surface tension allows the water to be more readily absorbed by humans, animals, and plants, and thus improves hydration and overall health.

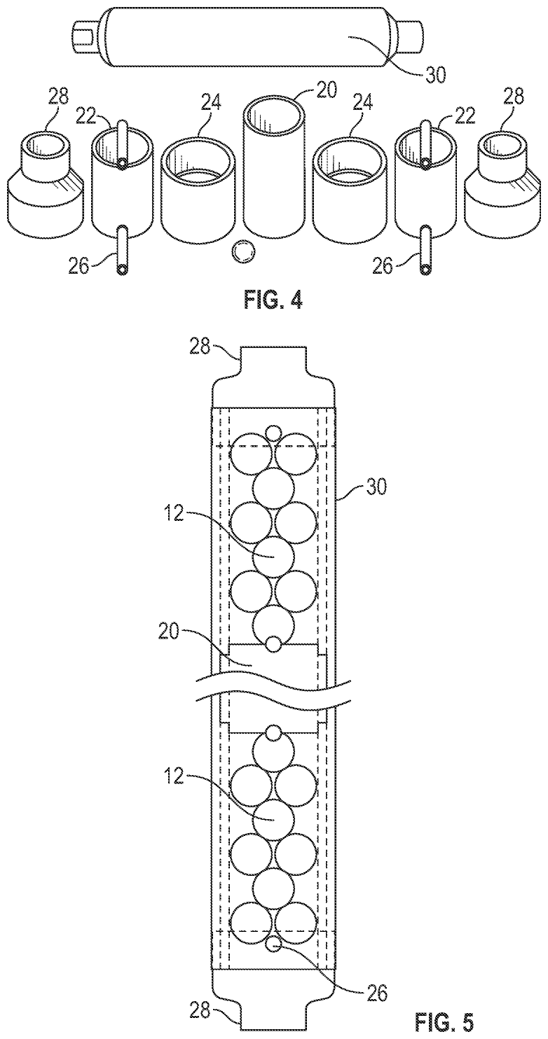

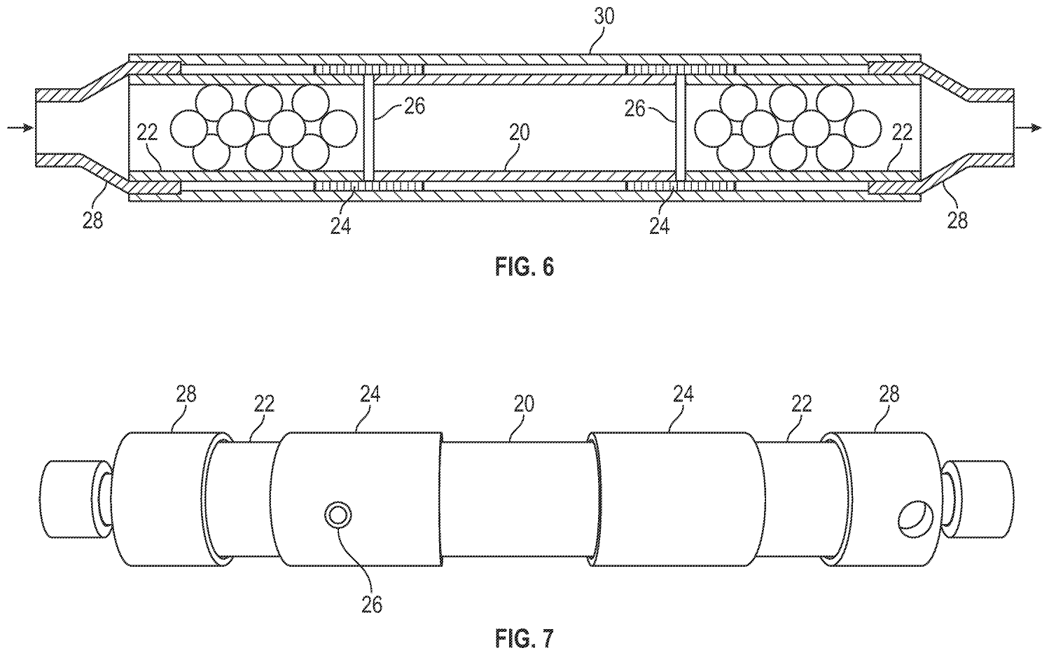

In a first embodiment, the conduit 10 is formed by a single pipe segment 16, as shown in FIGS. 2 and 3. In a second embodiment, the conduit 10 is formed with multiple pipe segments, as shown in FIGS. 4-7. For example, a center pipe section 20 is connected to outer pipe sections 22 by couplers 24. The balls 14 reside in the couplers 24, and are retained by pins 26 at each end of the couplers 24. The pins 26 can be installed in any convenient manner, such as by being pressed into grooves or holes at each end of the couplers 24. A reducer 28 is attached to the outer ends of the outer pipe sections. The reducers can have any desired reduced dimension, such as 1 inch, for attaching to a water line or hose, such as by a threaded connection. A stainless steel sleeve 30 is installed, such as by press fit, over the reducers 28, and couplers 24 so as to extend substantially the full length of the conduit 10. The sleeve 30 provides a durable shell to protect the components 20, 22, 24 and 28, which may be a plastic material, such as PVC. The couplers 24 and the reducers 28 may be secured to the sections 20, 22 using water-proof adhesive, plastic welding, or any other convenient method.

The treatment process modifies the normal, large, clustered molecules of the water, which are too large to penetrate the cells of a body, to a reduced size or micro-cluster of molecules which passes into the cells for improved hydration of the body.

The treated water, with its enhanced negative hydrogen ions, also functions to neutralize toxins in the body, which are normally positively charged. When the body cells are hydrated with the improved water resulting from the process of the present invention, the free radicals in the cells are eliminated by the electron donors.

The negatively charged hydrogen ions carry the electrons. The revitalized water provides an improved electrical interface at the cellular level, which depends on electrical conductivity, to transfer energy in the body, while also preserving minerals in the body, without losing the minerals through body fluids, such as urine and sweat. Thus, the revitalized water increases hydration at the cellular level for healthier bodily function.

The revitalized water resulting from the method of the present invention has increased negative hydrogen ions, which are powerful natural antioxidants to counteract damaging free radicals, which are major contributors to degenerative diseases. The negative hydrogen gives up its electron, without becoming an unstable harmful-free radical. The negative hydrogen establishes a biological terrain wherein harmful microbes (such as yeasts, bacteria, viruses, and other parasites) do not remain or survive. The negative hydrogen ions display natural alkalizers and antimicrobial agents to maintain cellular fluid balance. The revitalization process produces water having free electrons with a negative hydrogen complex, which is necessary as the raw material for the mitochondria, and the source within cells to produce energy. The hydrogen to which the free electrons are attached is utilized to combat available oxygen expressed as energy produced. The electrons are carried throughout the living body by attachment to the abundance of hydrogen ions in the rejuvenated water.

The conduit 10 may have shapes other than the circular shape shown in the drawings, such as oval, square, round, oblong, non-symmetrical, dimpled, or irregular, and the like. The conduit 10 can also be used with other liquids, such as wine, liquor, milk, syrups, oils, and other liquids which are consumed in one form or another.

The deflectors 14 can also have shapes other than the spherical balls shown in the drawings. For example, the deflectors may be cubes, squares, diamonds, triangular, oblong, or other irregular shapes. Also, the deflectors can be made out of non-metallic material, such as glass, plastic, ceramic, or acrylic. The pipe or pipe components may also be made of any material, such as plastic, PVC, CPVC, copper, stainless steel, iron, glass, carbon, carbon fiber, grafting, tungsten, aluminum, ceramic, cast, pot metal, clay tile, tin, acrylic, rubber, and other materials.

The water created by the revitalization process may be used in various applications, including livestock, poultry, fish, irrigation for agricultural and greenhouse plant production, carwashes, laundries, ponds, lakes, in aquariums, on the soil, and for human consumption. Furthermore, the process can be used with biological liquids and oils to control and dissipate odor from dead and decaying plants, animals or other contaminants. The revitalized water can also be used on various water shed products, pits, lagoons, tanks, septic, sewer treatment, drainage systems, and oil spills.

Thus, the person, animal, or plant which utilizes the revitalized water resulting from the methods of the present invention has improved hydration, reduced disease risk, and approved overall health. This restructuring of the water increases crop production or yield when used in agricultural irrigation systems, and increases growth in animals when used in livestock, poultry, and fish farms.

The present invention can also be used for hydrogen fuel production through the increased volume or quantity of negative hydrogen ions. The number of hydration layers of ions increases thermal conductivity or heat transfer, which increases caloric capacity due to the bonding angles created by the micro-cluster molecules. The revitalized water with improved hydrogen bonding allows the hydrogen layers to surround the usable ionic state of energy with higher specific heat. Thus, the revitalized water with increased hydrogen bonding and increased negative hydrogen ions with bio-photonic energy provides a positive or enhanced water for hydrogen fuel production.

The water treatment process of the present invention provides at least two benefits: (1) the water molecules are re-aligned into a hexagonal matrix with increased caloric capacity needed for energy transport into the body; and (2) life force energy produced by the treatment tube allows organisms to reproduce and increases absorption to stimulate root development in plants. The molecular re-alignment in the water results from the increased water energy. The life force energy is the bio photonic (sun light) energy. Energy is the molecular movement in objects, such as water, plants, animals, and humans.

Tests utilizing the treated water with reduced surface tension has shown positive results. For example, in tests on crops watered with the treated water of this invention, corn yield increased 10-20%, and soybean yield increased almost 10%. These results are believed to be due, in part, to loosening of the soil after watering, which enhances root growth, compared to compacted and crusted soil which has water runoff. Rye grass tests show increased forage quality in cattle feeding on the grass, with increases of 10% for protein, 19% for fiber, and 16% for fat, and decreases in nitrates in the rye grass from 7700 ppm to 3500 ppm, all leading to an increase in profits of $22/head. Similarly, in tests on turkeys consuming the treated water, profit increased 5-10% per bird. Dairy cattle which drank the treated water had increased mild production and increased pregnancy rates.

The treated water with reduced surface tension can be used for many purposes and in many industries, including agricultural crops, livestock, poultry, flower nurseries, car washes, restaurant cooking and cleaning, human and animal consumption, and other business and residential uses.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A method of treating water, comprising:
passing the water through a conduit having two sets of internal deflectors at opposite ends of the conduit, with a central portion of the conduit being unobstructed; and
whereby the water cavitates as it passes the around the sets of deflectors, and returns towards laminar flow between the sets of reflectors;
whereby the water exiting the conduit has reduced surface tension compared to the water entering the conduit.

2. The method of claim 1 wherein the water has increased hydrogen ionization after passing through the tube.

3. The method of claim 1 wherein electron activation of the water increases as the water passes through the tube.

4. The method of claim 1 wherein the water exiting the tube has decreased water molecule clusters.

5. The method of claim 1 wherein the deflectors are round.

6. The method of claim 1 wherein the deflectors are metal.

7. The method of claim 1 wherein the deflectors are demagnetized.

8. The method of claim 1 wherein the deflectors are arranged in an array.

9. The method of claim 1 wherein the deflectors are balls arranged in offset rows.

10. A method of lowering surface tension of water, comprising:
passing the water through a conduit connected to a water pipe;
the conduit having first and second sets of internal deflectors of demagnetized steel, the sets being spaced apart in the conduit, with a central longitudinal portion of the conduit between the sets of internal deflectors being free from deflectors; and
whereby the water is cavitated by the first set of deflectors, then non-cavitated in the central portion of the conduit, then cavitated again by the second set of deflectors, so as to increase negative hydrogen ions in the water.

11. The method of claim 10 wherein the deflectors are round.

12. The method of claim 10 wherein each set of the deflectors are arranged in 2×2 rows, with each row offset from an adjacent row.

13. The method of claim 10 wherein each set of deflectors includes a plurality of balls arranged in offset rows.

14. The method of claim 10 wherein the water increases in electron activity and decreases in molecular clusters while passing through the pipe.

15. A method of treating water, comprising:
directing the water through a tube; and
flowing the water around a first set of deflectors in the tube to create a first cavitation zone, then
flowing the water through the tube in a non-cavitation zone, then
flowing the water around a second set of deflectors in the tube to create a second cavitation zone,
whereby the sequential cavitation zones separated by the non-cavitation zone reduces surface tension of molecules in the water.

16. The method of claim 15 wherein the water flows substantially in a laminar manner in the non-cavitation zone.

17. The method of claim 16 wherein the treated water has increased negative hydrogen ions.

18. The method of claim 17 wherein the treated water has increased electron activity.

19. The method of claim 18 wherein the treated water has reduced molecular clusters.

20. The method of claim 19 wherein each set of deflectors includes a first row with a first pair of balls and a second row with a second pair of balls, and the first and second rows of balls are misaligned with respect to one another so as to nest together.
